(19) United States
(12) Patent Application Publication
(10) Pub. No.: US 2017/0204932 A1
(43) Pub. Date: Jul. 20, 2017

(54) PRESSURE BUFFERING DEVICE AND DAMPING-FORCE GENERATING MECHANISM

(71) Applicant: Showa Corporation, Gyoda City (JP)

(72) Inventor: Gota NAKANO, Gyoda City (JP)

(73) Assignee: Showa Corporation, Gyoda City (JP)

(21) Appl. No.: 15/327,879

(22) PCT Filed: Jun. 5, 2015
(86) PCT No.: PCT/JP2015/066294

§ 371 Date: Jan. 20, 2017

(30) Foreign Application Priority Data
Jul. 23, 2014 (JP) 2014-149906

(51) Int. Cl. F16F 9/516; F16F 9/348; F16F 9/346; B60G 13/08; F16F 9/18; F16F 9/32

(52) U.S. Cl. CPC F16F 9/516; F16F 9/185; F16F 9/3235; F16F 9/346; B60G 13/08; F16F 9/348; F16F 2222/12; F16F 2232/08

(57) ABSTRACT

A hydraulic-pressure buffering device includes a cylinder, a piston unit provided movably in the cylinder to partition a space in the cylinder into a first oil chamber and a second oil chamber, an outer side piston unit fixed to a rod unit, an inner side piston unit provided movably relative to the outer side piston unit, a first channel that allows a flow of oil from the first oil chamber to the second oil chamber, a second channel that allows a flow of the oil from the second oil chamber to the first oil chamber, a compression side valve unit fixed to the inner side piston unit and brought into contact with the outer side piston unit, and an extension side valve unit fixed to the outer side piston unit and brought into contact with the inner side piston unit.

### CROSS-REFERENCE TO RELATED PATENT APPLICATION

This application is a U.S. National Phase Application under 35 U.S.C. §371 of International Patent Application No. PCT/JP2015/066294, filed Jun. 5, 2015, and claims the benefit of Japanese Patent Application No. 2014-149906, filed on Jul. 23, 2014, all of which are incorporated by reference in its entirety herein. The International Application was published in Japanese on Jan. 28, 2016 as International Publication No. WO/2016/013311 under PCT Article 21(2).

### TECHNICAL FIELD

The present invention relates to a pressure buffering device and a damping-force generating mechanism.

### BACKGROUND ART

A suspension device of a vehicle such as an automobile includes a pressure buffering device in which a damping-force generating mechanism is used in order to appropriately reduce vibration transmitted from a road surface to a vehicle body during traveling, so as to improve riding comfort and steering stability. As an example of such a pressure buffering device, there is a pressure buffering device in which a damping force is changed by pressing a pressing member only against a valve provided on one side in an axial direction of a piston (see, for example, PTL 1).

### CITATION LIST

### Patent Literature

PTL 1: JP-H07-091476-A

### SUMMARY

### Technical Problem

In the related art, the damping force cannot be changed at a valve disposed on a side where the pressing member is not provided, for example. This means that, although a damping force of a flow of fluid generated according to movement in one direction of the piston can be changed, a damping force of a flow of the fluid generated according to movement in the other direction of the piston cannot be changed.

In the pressure buffering device of the related art, when it is attempted to change the damping forces generated according to movements in both the one direction and the other direction of the piston, an apparatus configuration inevitably becomes complicated.

An object of the present invention is to realize, with a simple configuration, changes in damping forces generated according to movements in both one direction and the other direction of a piston.

### Solution to Problem

To achieve the object, the present invention provides a pressure buffering device including: a cylinder that stores liquid; a piston provided movably in a cylinder axial direction in the cylinder, the piston partitioning a space in the cylinder into a first liquid chamber and a second liquid chamber; a first member fixed to a predetermined member; a second member provided movably relative to the first member; a first channel that forms a channel of a flow of the liquid from the first liquid chamber to the second liquid chamber caused according to the movement of the piston; a second channel that forms a channel of a flow of the liquid from the second liquid chamber to the first liquid chamber caused according to the movement of the piston; a first valve fixed to the second member and brought into contact with the first member to control the flow of the liquid in the first channel; and a second valve fixed to the first member and brought into contact with the second member to control the flow of the liquid in the second channel.

By adopting such a configuration, for example, simply by moving the second member in the one direction relative to the first member, the distance between the first member and the second member is changed, and damping forces generated in the first valve and the second valve respectively fixed to the first member and the second member can be changed. Therefore, it is possible to realize, with a simple configuration, changes in damping forces generated according to movements in both the one direction and the other direction of the piston.

### Advantageous Effects of Invention

According to the present invention, it is possible to realize, with a simple configuration, changes in damping forces generated according to movements in both the one direction and the other direction of a piston.

### BRIEF DESCRIPTION OF THE DRAWINGS

FIG. 1 is an overall configuration diagram of a hydraulic-pressure buffering device in a first embodiment.

FIG. 2 is an enlarged view around a piston unit in the first embodiment indicated by an arrow II in FIG. 1.

FIGS. 3A and 3B are diagrams showing flows of oil of the hydraulic-pressure buffering device in the first embodiment.

FIG. 4 is a diagram for explaining a change in a damping force in the piston unit.

FIG. 5 is a diagram showing a piston unit in a second embodiment.

FIG. 6 is a diagram showing a piston unit in a third embodiment.

FIG. 7 is a diagram showing a piston unit in a fourth embodiment.

FIG. 8 is a diagram showing a piston unit in a fifth embodiment.

FIG. 9 is a diagram showing a piston unit in a sixth embodiment.

FIG. 10 is a diagram showing a hydraulic-pressure buffering device in a seventh embodiment.

### DESCRIPTION OF EMBODIMENTS

Embodiments of the present invention are explained in detail below with reference to the accompanying drawings.

### First Embodiment

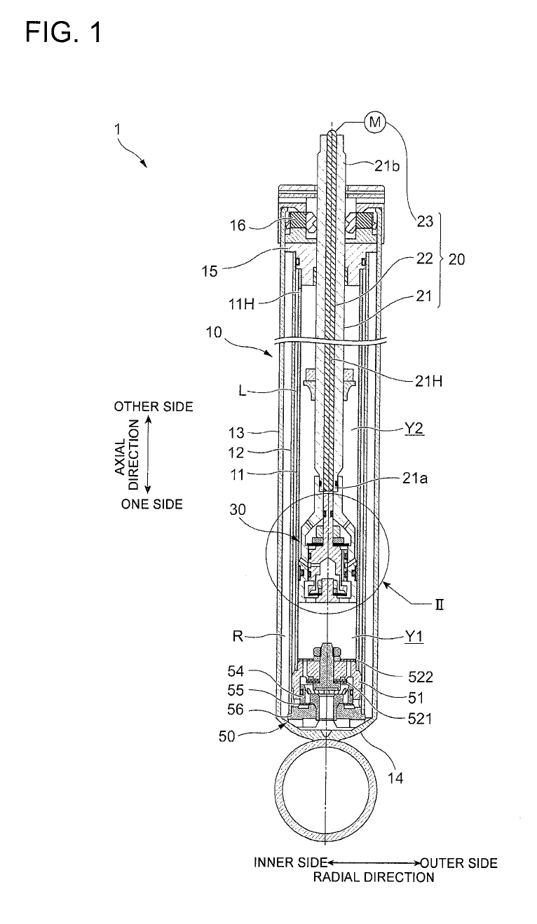

FIG. 1 is an overall configuration diagram of a hydraulic-pressure buffering device 1 in this embodiment.

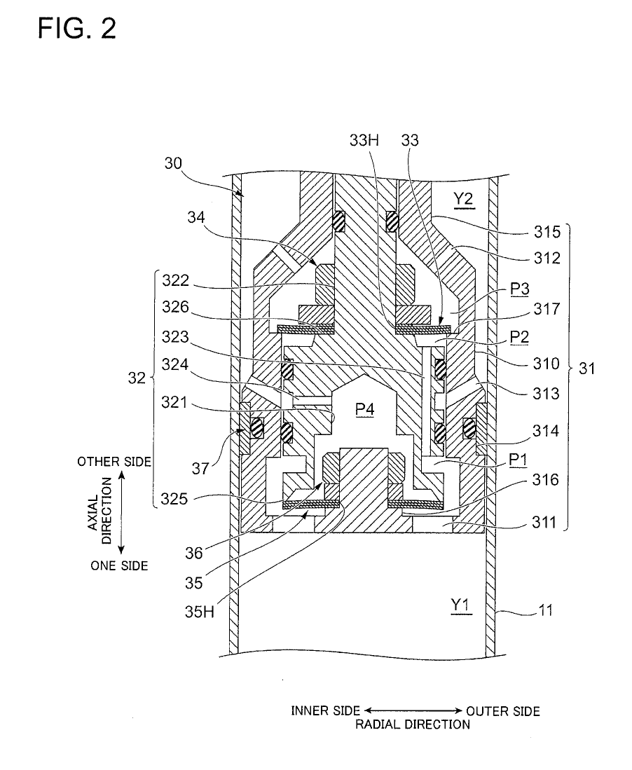

FIG. 2 is an enlarged view around a piston unit 30 indicated by an arrow II in FIG. 1. Note that, in the following explanation, a lower side in the figure in the “axial direction” of the hydraulic-pressure buffering device 1 shown in FIG. 1 is referred to as “one side” and an upper side in the figure is referred to as “the other side”. The left-right direction of the hydraulic-pressure buffering device 1 shown in FIG. 1 is referred to as “radial direction”, a center axis side is referred to as “inner side”, and a side away from the center axis is referred to as “outer side”.

[Configuration and Functions of the Hydraulic-Pressure Buffering Device 1]The hydraulic-pressure buffering device 1 (a pressure buffering device) includes, as shown in FIG. 1, a cylinder unit 10, a rod unit 20, the other side of which is provided to project to the outside of the cylinder unit 10 and one side of which is slid ably inserted into the inside of the cylinder unit 10, the piston unit 30 provided at an end portion on one side of the rod unit 20, and a bottom valve unit 50 disposed at an end portion on one side of the cylinder unit 10.

The cylinder unit 10 includes a cylinder 11, an outer cylinder body 12 provided on the outer side of the cylinder 11, a damper case 13 provided further on the outer side of the outer cylinder body 12, a bottom section 14 provided at an end portion on one side in the axial direction of the damper case 13, a rod guide 15 that guides the rod unit 20, and an oil seal 16 disposed at an end portion on the other side in the axial direction of the rod guide 15.

The rod unit 20 (a predetermined member) includes a rod member 21, which is a hollow bar-like member, a transmission member 22 provided on the inside of the rod member 21, and moving means 23 provided on the other side of the rod member 21.

The piston unit 30 includes, as shown in FIG. 2, an outer side piston unit 31 (a first member) fixed to the rod member 21, an inner side piston unit 32 (a second member) provided on the radial direction inner side of the outer side piston unit 31, a compression side valve unit 33 (a first valve) provided on the other side of the inner side piston unit 32, a compression side fixing section 34 provided on the other side of the compression side valve unit 33, an extension side valve unit 35 (a second valve) provided on one side of the outer side piston unit 31, an extension side fixing section 36 provided on the other side of the extension side valve unit 35, and a piston ring 37 attached to the radial direction outer side of the outer side piston unit 31.

The piston unit 30 forms a first intermediate chamber PA, a second intermediate chamber P2P, a third intermediate chamber P3, and a fourth intermediate chamber P4 that store oil separately from a first oil chamber Y1 and a second oil chamber Y2.

The first intermediate chamber P1 is formed by the outer side piston unit 31 and the inner side piston unit 32 on one side of the piston unit 30. The second intermediate chamber P2 is formed by the outer side piston unit 31, the inner side piston unit 32, and the compression side valve unit 33 on the other side of the piston unit 30. The third intermediate chamber P3 is formed by the outer side piston unit 31 and the compression side valve unit 33 on the other side of the piston unit 30. The fourth intermediate chamber P4 is formed by the inner side piston unit 32 and the extension side valve unit 35 on one side of the piston unit 30.

As shown in FIG. 1 and FIG. 2, the piston unit 30 partitions a space in the cylinder 11 into the first oil chamber Y1 and the second oil chamber Y2 that store the oil. In this embodiment, the first oil chamber Y1 is formed on one side of the piston unit 30 and the second oil chamber Y2 is formed on the other side of the piston unit 30.

The bottom valve unit 50 includes, as shown in FIG. 1, first valve body 51 including a plurality of oil paths, a compression side valve 521 provided on one side of the first valve body 51, an extension side valve 522 provided on the other side of the first valve body 51, a second valve body 54 including a plurality of oil paths and disposed on one side of the first valve body 51, a check valve 55 provided on one side of the second valve body 54, and a base member 56 disposed on one side of the check valve 55.

The bottom valve unit 50 is provided at an end portion on one side of the hydraulic-pressure buffering device 1 and partitions a reservoir chamber R explained below and the first oil chamber Y1.

The hydraulic-pressure buffering device 1 (the pressure buffering device) in the first embodiment includes, as shown in FIG. 1 and FIG. 2, the cylinder 11 (a cylinder) that stores liquid (oil), the piston unit 30 provided movably in a cylinder axial direction in the cylinder 11, the piston unit 30 partitioning a space in the cylinder 11 into the first oil chamber Y1 (a first liquid chamber) and the second oil chamber Y2 (a second liquid chamber), the outer side piston unit 31 (a first member) fixed to the rod unit 20 (the predetermined member), the inner side piston unit 32 (a second member) provided movably relative to the outer side piston unit 31, a first channel that forms a channel of a flow of the oil from the first oil chamber Y1 to the second oil chamber Y2 caused according to the movement of the piston unit 30, a second channel that forms a channel of a flow of the oil from the second oil chamber Y2 to the first oil chamber Y1 caused according to the movement of the piston unit 30, the compression side valve unit 33 (the first valve) fixed to the inner side piston unit 32 and brought into contact with the outer side piston unit 31 to control the flow of the oil in the first channel, and the extension side valve unit 35 (the second valve) fixed to the outer side piston unit 31 and brought into contact with the inner side piston unit 32 to control the flow of the oil in the second channel

These components are explained in detail below.

[Configuration and Functions of the Cylinder Unit 10]

As shown in FIG. 1, the cylinder 11 is formed in a thin cylindrical shape opened on one side and the other side. An end portion on one side of the cylinder 11 is closed by the bottom valve unit 50. An end portion on the other side is closed by the rod guide 15. The cylinder 11 stores the oil on the inside.

In the cylinder 11, the piston unit 30 is provided slidably in the axial direction with respect to the inner circumferential surface of the cylinder 11. Further, the cylinder 11 includes, on the other side and further on one side than the rod guide 15, a cylinder opening 11H opening in the radial direction. The cylinder opening 11H causes the second oil chamber Y2 of the cylinder 11 and a communication path L explained below to communicate with each other. The cylinder opening 11H enables a flow of the oil between the second oil chamber Y2 and the communication path L.

The outer cylinder body 12 is formed in a thin cylindrical shape opened on one side and the other side. The outer cylinder body 12 is provided on the outer side of the cylinder 11 and the inner side of the damper case 13. The outer cylinder body 12 is disposed with the inner circumference spaced a predetermined interval apart from the outer circumference of the cylinder 11. The outer cylinder body 12 forms the communication path L, through which the oil can flow, between the outer cylinder body 12 and the cylinder 11. The communication path L serves as a route of the oil between the first and second oil chambers Y1 and Y2 and the reservoir chamber R explained below.

The damper case 13 is formed longer than the cylinder 11 and the outer cylinder body 12. The damper case 13 houses the cylinder 11 and the outer cylinder body 12 on the inner side in the axial direction and the radial direction. The damper case 13 is disposed with the inner circumference spaced a predetermined interval apart from the outer circumference of the outer cylinder body 12. The damper case 13 forms the reservoir chamber R between the damper case 13 and the outer cylinder body 12. The reservoir chamber R absorbs the oil in the cylinder 11 and supplies the oil into the cylinder 11 to compensate for the oil equivalent to moved volume in the cylinder 11 of the rod unit 20.

The bottom section 14 is provided at an end portion on one side of the damper case 13 and closes the end portion on one side of the damper case 13. The rod guide 15 supports the rod unit 20 movably in the axial direction. The oil seal 16 is fixed to an end portion on the other side of the damper case 13 and prevents a leak of the oil in the cylinder unit 10 and intrusion of foreign matters into the cylinder unit 10.

[Configuration and Functions of the Rod Unit 20]

As shown in FIG. 1, the rod member 21 is a bar-like member extending long in the axial direction. The rod member 21 includes, on the inside, a through-hole 21H piercing through the rod member 21 in the axial direction. The rod member 21 includes a one side attaching section 21a provided at an end portion on one side and an other side attaching section 21b provided at an end portion on the other side.

The one side attaching section 21a of the rod member 21 holds the piston unit 30. A coupling member (not shown in the figure) for coupling the hydraulic-pressure buffering device 1 to a vehicle body of an automobile or the like is attached to the other side attaching section 21b of the rod member 21.

The transmission member 22 is a bar-like member extending in the axial direction. The outer diameter of the transmission member 22 is formed small compared with the inner diameter of the through-hole 21H of the rod member 21. The transmission member 22 is provided movably in the axial direction on the inner side of the rod member 21. As shown in FIG. 2, the transmission member 22 is provided such that an end portion on one side is capable of coming into contact with the inner side piston unit 32 of the piston unit 30.

The moving means 23 moves the transmission member 22 in the axial direction and applies a load to the compression side valve unit 33 and the extension side valve unit 35 via the transmission member 22. The inner side piston unit 32 applies a load to the compression side valve unit 33 and the extension side valve unit 35 in one direction. Therefore, in this embodiment, as the moving means 23 for applying the load, moving means for applying the load to the inner side piston unit 32 in a single direction is used.

Note that a mechanism of the moving means 23 for moving the transmission member 22 is not particularly limited. However, in this embodiment, for example, a linear motion actuator that converts a rotational motion of a motor into a rectilinear motion using a mechanism such as a screw is used.

The moving means 23 may apply the load to the inner side piston unit 32 in “both directions” rather than only applying the load to the inner side piston unit 32 in the “single direction”.

[Configuration and Functions of the Piston Unit 30]

(Outer Side Piston Unit 31)

The outer side piston unit 31 includes, as shown in FIG. 2, a hollow section 310 formed in a hollow shape, an outer side first oil path 311 formed on one side of the hollow section 310, an outer side second oil path 312 formed on the other side of the hollow section 310, an outer side third oil path 313 formed between the outer side first oil path 311 and the outer side second oil path 312, a ring holding section 314 formed on the radial direction outer side of the hollow section 310, a connecting section 315 formed at an end portion on the other side, an extension side valve holding section 316 formed on one side, and a compression side valve pressing section 317 formed on the inner side and the other side of the hollow section 310.

The inner diameter of the hollow section 310 is formed substantially equal to the outer diameter of a concave section 321 explained below of the inner side piston unit 32.

The outer side first oil path 311 is a through-hole opening in the axial direction. The outer side first oil path 311 communicates with the first intermediate chamber P1 and the fourth intermediate chamber P4, which is opened by the extension side valve unit 35, on the inner side of the hollow section 310 and communicates with the first oil chamber Y1 on the outer side of the hollow section 310. The outer side first oil path 311 (a first through-hole) allows the oil to flow into the hollow section 310 during a compression stroke in which the oil flows from the first oil chamber Y1 to the second oil chamber Y2.

The outer side second oil path 312 is a through-hole opening obliquely to the axial direction. The outer side second oil path 312 communicates with the third intermediate chamber P3 on the inner side of the hollow section 310 and communicates with the second oil chamber Y2 on the outer side of the hollow section 310. The outer side second oil path 312 (a second through-hole) allows the oil to flow into the hollow section 310 during an extension stroke in which the oil flows from the second oil chamber Y2 to the first oil chamber Y1.

The outer side third oil path 313 is a through-hole opening in the radial direction. The outer side third oil path 313 communicates with an inner side second oil path 324 explained below of the inner side piston unit 32 on the inner side of the hollow section 310 and communicates with the second oil chamber Y2 on the outer side of the hollow section 310.

The ring holding section 314 is a groove formed in the circumferential direction. The ring holding section 314 holds the piston ring 37.

The connecting section 315 is a through-hole pierced through in the axial direction. The connecting section 315 is connected to the one side attaching section 21a of the rod member 21 (see FIG. 1). In the connecting section 315, a shaft section 322 explained below of the inner side piston unit 32 is housed movably in the axial direction on the inner side.

The extension side valve holding section 316 is a portion projecting toward the other side in the hollow section 310. The extension side valve holding section 316 holds the extension side valve unit 35. A male screw is formed in the extension side valve holding section 316. The extension side fixing section 36 is fixed to the extension side valve holding section 316.

In the inner circumference of the hollow section 310, the compression side valve pressing section 317 is formed by a step formed by a portion larger than the outer diameter of the compression side valve unit 33 on the other side and a portion smaller than the outer diameter of the compression side valve unit 33 on one side. The compression side valve pressing section 317 forms a surface facing the other side. The compression side valve pressing section 317 is in contact with the compression side valve unit 33 located on the other side.

(Inner Side Piston Unit 32)

The inner side piston unit 32 includes a concave section 321, a shaft section 322 provided on the other side of the concave section 321, an inner side first oil path 323 formed in the concave section 321, an inner side second oil path 324 formed in the concave section 321, an extension side valve pressing section 325 provided on one side, and a compression side valve holding section 326 provided on the other side.

The concave section 321 is formed to open toward one side. In this embodiment, the concave section 321 forms the fourth intermediate chamber P4 on the inner side.

The shaft section 322 is formed to extend further toward the other side in the axial direction on the other side of the concave section 321. A male screw is formed in the shaft section 322. The compression side fixing section 34 is fixed to the shaft section 322. Further, the shaft section 322 is in contact with the transmission member 22 (see FIG. 1) on the other side.

The inner side first oil path 323 is a through-hole formed in the axial direction in the concave section 321. The inner side first oil path 323 communicates with the first intermediate chamber P1 on one side and communicates with the second intermediate chamber P2 on the other side.

The inner side second oil path 324 is a through-hole formed in the radial direction in the concave section 321. The inner side second oil path 324 communicates with the fourth intermediate chamber P4 on the radial direction inner side and communicates with the outer side third oil path 313 of the outer side piston unit 31 on the radial direction outer side. Note that, as explained below, the inner side piston unit 32 is provided movably in the axial direction with respect to the outer side piston unit 31. Even when the inner side piston unit 32 moves, the inner side second oil path 324 is opposed to the outer side third oil path 313 to enable the oil to flow between the inner side second oil path 324 and the outer side third oil path 313.

In this embodiment, the extension side valve pressing section 325 is a part formed in a substantially cylindrical shape. The outer diameter of the extension side valve pressing section 325 is set substantially the same as the outer diameter of the extension side valve unit 35. In this embodiment, the extension side valve pressing section 325 is in contact with the outer edge portion of the extension side valve unit 35.

The compression side valve holding section 326 is formed by a step between the shaft section 322 and the concave section 321.

The compression side valve holding section 326 holds the compression side valve unit 33.

(Compression Side Valve Unit 33)

In this embodiment, the compression side valve unit 33 is configured by laying, one on top of another, a plurality of disc-like metal plate materials in which an opening section 33H for allowing the shaft section 322 to pass is formed. Note that the metal plate materials configuring the compression side valve unit 33 may be a single metal plate material without being limited to the plurality of metal plate materials.

(Compression Side Fixing Section 34)

The compression side fixing section 34 fixes the compression side valve unit 33 to the inner side piston unit 32 while pressing the compression side valve unit 33 toward the compression side valve holding section 326 side on the other side of the compression side valve unit 33. Consequently, the compression side fixing section 34 acts such that the compression side valve unit 33 moves integrally with the inner side piston unit 32.

(Extension Side Valve Unit 35)

In this embodiment, the extension side valve unit 35 is configured by laying a plurality of disk-like metal plate materials, in which an opening section 35H for allowing the extension side valve holding section 316 to pass is formed, one on top of another. Note that the metal plate materials configuring the extension side valve unit 35 may be a single metal plate material rather than being limited to the plurality of metal plate materials.

(Extension Side Fixing Section 36)

The extension side fixing section 36 fixes the extension side valve unit 35 to the outer side piston unit 31 while pressing the extension side valve unit 35 toward the extension side valve holding section 316 side on the other side of the extension side valve unit 35. Consequently, the extension side fixing section 36 acts such that the extension side valve unit 35 moves integrally with the outer side piston unit 31.

(Piston Ring 37)

The piston ring 37 is provided slidably in contact with the inner circumferential surface of the cylinder 11. The piston ring 37 reduces frictional resistance between the cylinder 11 and the piston unit 30.

[Configuration and Functions of the Bottom Valve Unit 50]

As shown in FIG. 1, the first valve body 51 includes a plurality of oil paths formed to extend in the axial direction. The compression side valve 521 and the extension side valve 522 control a flow of the oil in the plurality of oil paths formed in the first valve body 51. The first valve body 51 enables a flow of the oil across the first valve body 51 in the communication path L.

The second valve body 54 includes a plurality of oil paths formed to extend in the axial direction. The check valve 55 controls a flow of the oil in the plurality of oil paths of the second valve body 54.

The base member 56 forms a channel in which the oil flows among the first oil chamber Y1, the reservoir chamber R, and the communication path L.

The bottom valve unit 50 controls a flow of the oil to the first oil chamber Y1, the reservoir chamber R, and the communication path L with respect to a flow of the oil caused according to movement in the axial direction of the piston unit 30.

Operation of the Hydraulic-Pressure Buffering Device 1 in the First Embodiment

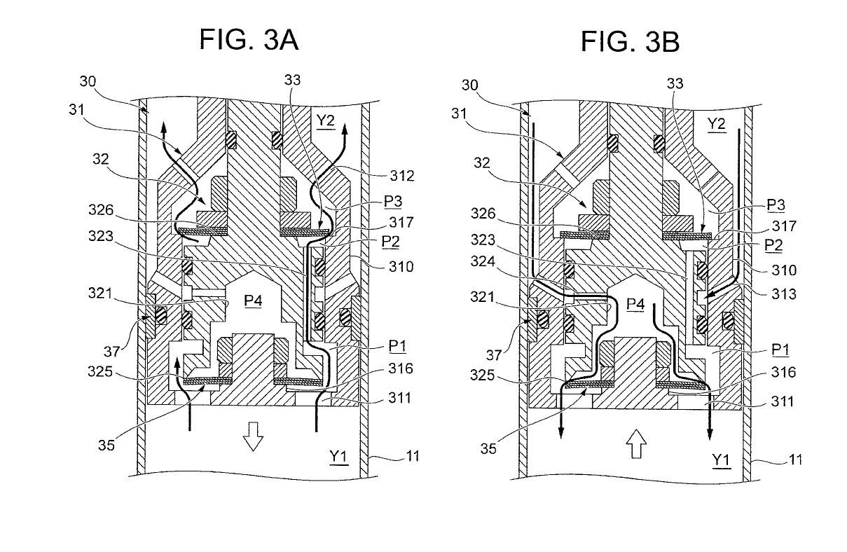

FIGS. 3A and 3B are diagrams showing a flow of the oil of the hydraulic-pressure buffering device 1 in the first embodiment.

Note that FIG. 3A shows a flow of the oil during the compression stroke and FIG. 3B shows a flow of the oil during the extension stroke.

(During Compression Stroke)

First, the flow of the oil during the compression stroke of the hydraulic-pressure buffering device 1 is explained.

As shown in FIG. 3A, when the piston unit 30 moves to one side in the axial direction with respect to the cylinder 11 as indicated by a white arrow, the oil in the first oil chamber Y1 is pushed by the movement of the piston unit 30 and the pressure in the first oil chamber Y1 rises.

The oil, the pressure of which is increased in the first oil chamber Y1, flows into the first intermediate chamber P1 on the inside of the piston unit 30 from the outer side first oil path 311. Further, the oil in the first intermediate chamber P1 flows in the inner side first oil path 323 and flows to the second intermediate chamber P2. The oil flows into the third intermediate chamber P3 while opening the compression side valve unit 33. Thereafter, the oil flows out to the second oil chamber Y2 through the outer side second oil path 312.

In the hydraulic-pressure buffering device 1 in this embodiment, a damping force during the compression stroke is generated by resistance caused when the oil flows in the compression side valve unit 33.

Note that, during the compression stroke, in the bottom valve unit 50, as shown in FIG. 1, the oil in the first oil chamber Y1, the pressure of which is increased by the movement to one side in the axial direction of the piston unit 30, flows into the second oil chamber Y2 through the communication path L and the cylinder opening 11H. The oil flows out to the reservoir chamber R in the bottom valve unit 50.

(During Extension Stroke)

As shown in FIG. 3B, when the piston unit 30 moves to the other side in the axial direction with respect to the cylinder 11 as indicated by a white arrow, the oil in the second oil chamber Y2 is pushed by the movement of the piston unit 30 and the pressure in the second oil chamber Y2 rises.

Note that, as shown in FIG. 1, even if the oil happens to flow from the cylinder opening 11H through the communication path L, a flow of the oil from the second oil chamber Y2 to the first oil chamber Y1 through the communication path L is prevented by the bottom valve unit 50.

As shown in FIG. 3B, the oil, the pressure of which is increased in the second oil chamber Y2, flows into the inside of the piston unit 30 from the outer side third oil path 313. Further, the oil flows into the fourth intermediate chamber P4 from the inner side second oil path 324. The oil opens the extension side valve unit 35 and flows out to the first oil chamber Y1 through the outer side first oil path 311.

In the hydraulic-pressure buffering device 1 in this embodiment, a damping force during the extension stroke is generated by resistance caused when the oil flows in the extension side valve unit 35.

In the bottom valve unit 50, as shown in FIG. 1, the pressure in the first oil chamber Y1 drops according to the movement to the other side in the axial direction of the piston unit 30. Then, the pressure in the first oil chamber Y1 is low relative to the reservoir chamber R. Therefore, the oil in the reservoir chamber R flows into the first oil chamber Y1 in the bottom valve unit 50.

[Concerning Change Control for a Damping Force in the Piston Unit 30]

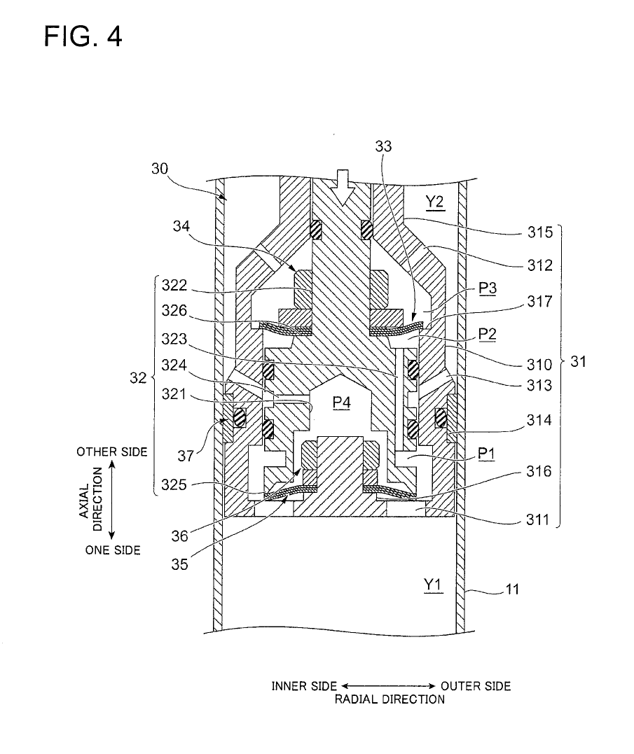

FIG. 4 is a diagram for explaining a change in a damping force in the piston unit 30. Subsequently, change control for a damping force in the piston unit 30 of the hydraulic-pressure buffering device 1 is explained.

As shown in FIG. 1, the transmission member 22 is pushed toward one side in the axial direction by a fixed amount by the moving means 23. Thus, the inner side piston unit 32 in contact with the transmission member 22 is caused to move to one side according to the movement to one side of the transmission member 22.

Then, as shown in FIG. 4, the compression side valve unit 33 fixed to the inner side piston unit 32 also starts to move to one side. At this point, the compression side valve unit 33 is in contact with the compression side valve pressing section 317 of the outer side piston unit 31 on the outer side in the radial direction. Therefore, in a state in which the compression side valve unit 33 is restricted from moving to one side on the radial direction outer side, the radial direction inner side is pushed to one side and deformed.

Further, according to the movement to one side of the inner side piston unit 32, the extension side valve pressing section 325 provided at the end portion on one side starts to move to one side. The extension side valve pressing section 325 comes into contact with the extension side valve unit 35 on the radial direction outer side. Therefore, in a state in which the extension side valve unit 35 is restricted from moving to one side (the axial direction upper side) on the radial direction inner side by the extension side valve holding section 316, the radial direction outer side is pushed (to the axial direction upper side) by the extension side valve pressing section 325 and deformed.

As explained above, in the hydraulic-pressure buffering device 1 in this embodiment, simply by moving the inner side piston unit 32 in one direction with the moving means 23, it is possible to deform both of the compression side valve unit 33 and the extension side valve unit 35. The compression side valve unit 33 and the extension side valve unit 35 are deformed in advance by the moving means 23, whereby a force necessary when the oil is caused to open the compression side valve unit 33 and the extension side valve unit 35 increases. Therefore, the resistance of the oil flowing in the compression side valve unit 33 and the extension side valve unit 35 increases. As a result, a damping force generated in the hydraulic-pressure buffering device 1 increases.

Note that, since the moving means 23 controls the inner side piston unit 32 to move in the other direction (the axial direction upper side), the deformation amount of the compression side valve unit 33 and the extension side valve unit 35 decreases. In this case, it is possible to reduce the damping force generated in the hydraulic-pressure buffering device 1.

As explained above, in the hydraulic-pressure buffering device 1 in this embodiment, simply by moving the transmission member 22 and the like in one direction with respect to the inner side piston unit 32, it is possible to collectively perform the changes in the damping forces in the flows in both the directions of the extension stroke and the compression stroke.

In this way, in the hydraulic-pressure buffering device 1 in this embodiment, it is possible to realize, with a simple configuration, the changes in the damping forces in the piston unit 30 generated according to the movements in both the one direction and the other direction of the piston unit 30.

It is also possible to change the generated damping forces according to, for example, setting of the numbers of metal members configuring the compression side valve unit 33 and the extension side valve unit 35. In particular, simply by differentiating the numbers of metal members in the compression side valve unit 33 and the extension side valve unit 35, it is possible to differentiate the damping forces generated in the compression stroke and the extension stroke. Therefore, in the hydraulic-pressure buffering device 1 according to this embodiment, it is possible to easily diversify setting widths of the generated damping forces.

### Second Embodiment

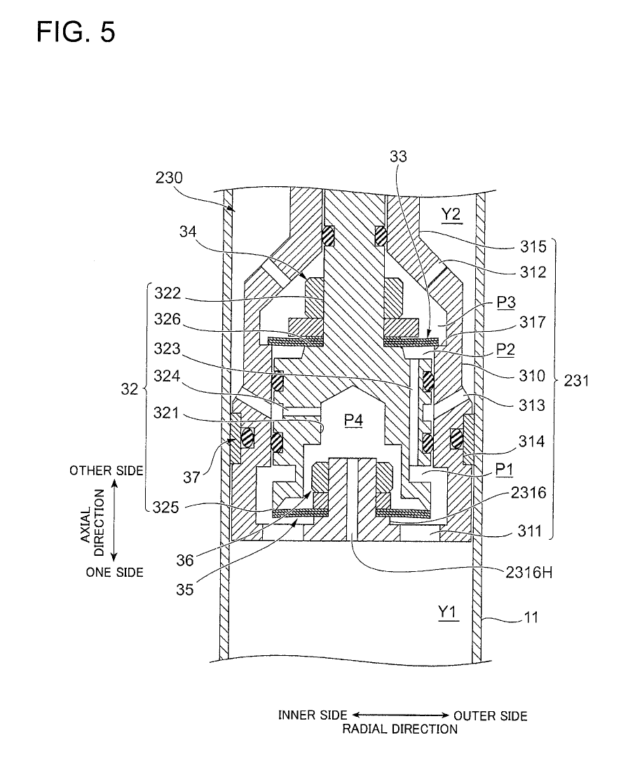

FIG. 5 is a diagram showing a piston unit 230 in a second embodiment.

Note that, in the second embodiment, components same as the components in the first embodiment are denoted by the same reference numerals and signs and detailed explanation of the components is omitted.

As shown in FIG. 5, the piston unit 230 in the second embodiment is the same as the piston unit 30 in the first embodiment in a basic configuration but is different in that the piston unit 230 includes an extension side valve holding section 2316. The extension side valve holding section 2316 is explained in detail below.

Similarly to the extension side valve holding section 316 in the first embodiment, the extension side valve holding section 2316 holds the extension side valve unit 35. In this embodiment, the extension side valve holding section 2316 includes a through-hole 2316H piercing through the extension side valve holding section 2316 in the axial direction.

The through-hole 2316H communicates with the first oil chamber Y1 on one side and communicates with the fourth intermediate chamber P4 on the other side. Therefore, the through-hole 2316H enables the oil to flow between the first oil chamber Y1 and the second oil chamber Y2 through the fourth intermediate chamber P4, the inner side second oil path 324, and the outer side third oil path 313. That is, in the second embodiment, by forming the through-hole 2316H in the extension side valve holding section 2316, a bypass path for enabling the flow of the oil between the first oil chamber Y1 and the second oil chamber Y2 is provided separately from a channel in which the oil flows in the compression side valve unit 33 and the extension side valve unit 35 in the piston unit 230.

In the piston unit 230 in the second embodiment configured as explained above, it is possible to change the magnitude of a generated damping force according to speed. Changes in the magnitudes of generated damping forces at the time when the piston unit 230 moves at low speed V1 and at the time when the piston unit 230 moves at high speed V2, for example, during the compression stroke are explained below.

For example, when the piston unit 230 moves at the low speed V1, the oil flows mainly through the through-hole 2316H configuring the bypass path. The oil flows from the first oil chamber Y1 to the second oil chamber Y2. In this state, the through-hole 2316H narrows the flow of the oil (in other words, applies fluid resistance to the oil) and generates a predetermined damping force.

On the other hand, when the piston unit 230 moves at the high speed V2, the oil cannot be sufficiently fed to the second oil chamber Y2 only by the through-hole 2316H. Therefore, as explained with reference to FIG. 3A, the flow of the oil flowing in the compression side valve unit 33 occurs. A damping force generated at this point is higher than a damping force generated by the flow of the oil through the through-hole 2316H.

As explained above, in the second embodiment, it is possible to change the generated damping force according to the speed. Note that, as in the first embodiment, it is also possible to change the magnitudes of the damping forces generated in the compression side valve unit 33 and the extension side valve unit 35. Therefore, it is possible to perform setting of a variety of damping forces in the hydraulic-pressure buffering device 1.

Note that, in the second embodiment, an advancing and retracting member such as a needle that advances and retracts with respect to the through-hole 2316H may be provided to control an amount of the oil flowing through the through-hole 2316H. Further, for example, the advancing and retracting member may be provided integrally in the inner side piston unit 32 to move together with the inner side piston unit 32.

### Third Embodiment

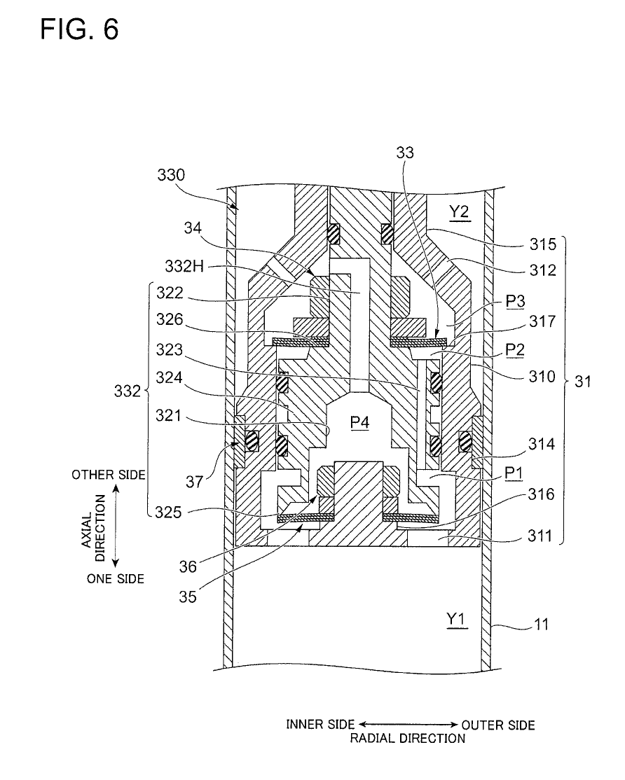

FIG. 6 is a diagram showing a piston unit 330 in a third embodiment.

Note that, in the third embodiment, components same as the components in the other embodiments are denoted by the same reference numerals and signs and detailed explanation of the components is omitted.

As shown in FIG. 6, the piston unit 330 in the third embodiment is the same as the piston unit 30 in the first embodiment in a basic configuration but is different in that an inner side piston unit 332 includes an inner side channel 332H. In the following explanation, the inner side channel 332H is explained in detail.

The inner side piston unit 332 includes, on the inner side of the shaft section 322, the inner side channel 332H formed in the radial direction and the axial direction. The inner side channel 332H communicates with the fourth intermediate chamber P4 on one side and communicates with the third intermediate chamber P3 on the other side. The inner side channel 332H enables, on the inner side of the inner side piston unit 32, a flow of the oil between the outer side first oil path 311 (the first through-hole) and the outer side second oil path 312 (the second through-hole).

Note that, in the third embodiment, the outer side piston unit 31 does not include the outer side third oil path 313 in the first embodiment. The inner side piston unit 332 does not include the inner side second oil path 324 in the first embodiment.

In the hydraulic-pressure buffering device 1 in the third embodiment configured as explained above, during the extension stroke, it is possible to realize a flow of the oil from the second oil chamber Y2 to the first oil chamber Y1 with the inner side channel 332H. Consequently, for example, it is unnecessary to form the outer side third oil path 313 in the outer side piston unit 31. It is possible to realize simplification of machining man-hour during manufacturing and members.

### Fourth Embodiment

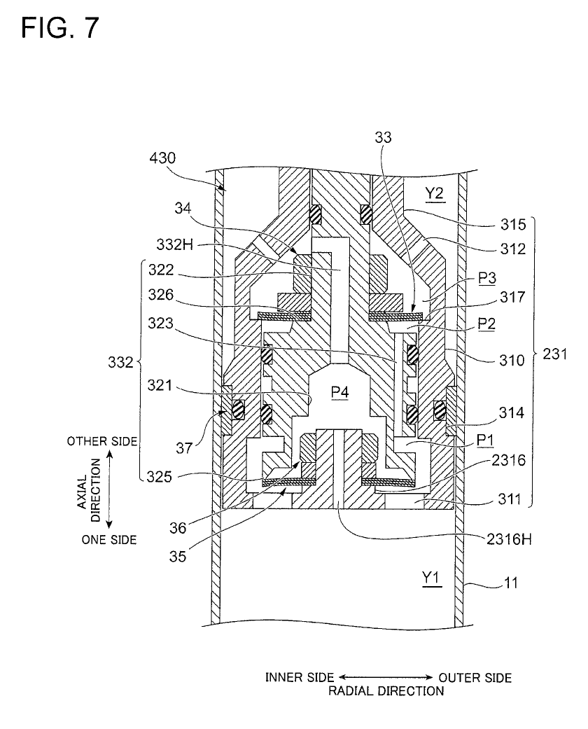

FIG. 7 is a diagram showing a piston unit 430 in a fourth embodiment. Note that, in the fourth embodiment, components same as the components in the other embodiments are denoted by the same reference numerals and signs and detailed explanation of the components is omitted.

As shown in FIG. 7, the piston unit 430 in the fourth embodiment includes the through-hole 2316H in the second embodiment and the inner side channel 332H in the third embodiment. The through-hole 2316H and the inner side channel 332H in the third embodiment are formed on the same row.

In the hydraulic-pressure buffering device 1 in the fourth embodiment configured as explained above, it is possible to change, with the through-hole 2316H, a generated damping force according to speed. Further, it is also possible to realize, with the inner side channel 332H, simplification of man-hour during manufacturing and component configurations.

### Fifth Embodiment

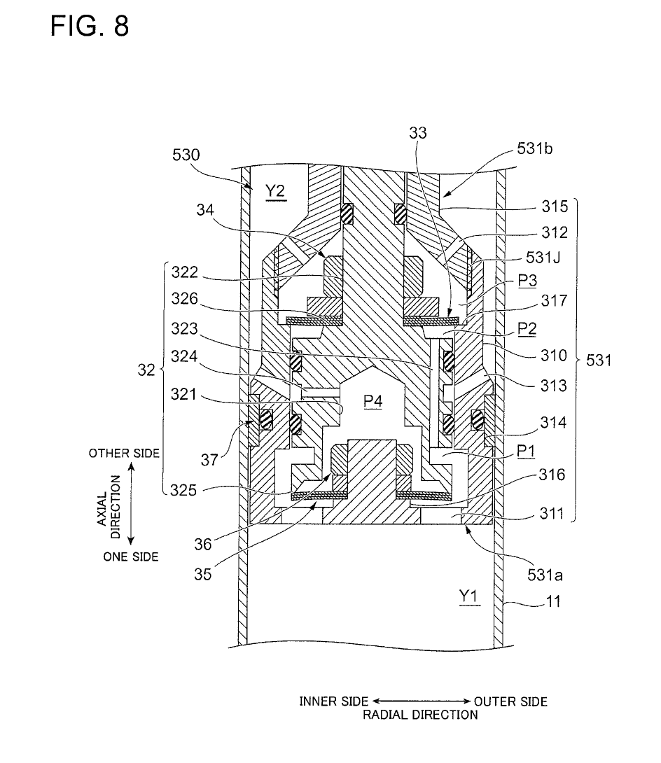

FIG. 8 is a diagram showing a piston unit 530 in a fifth embodiment.

Note that, in the fifth embodiment, components same as the components in the other embodiments are denoted by the same reference numerals and signs and detailed explanation of the components is omitted.

As shown in FIG. 8, in the piston unit 530 in the fifth embodiment, the configuration of an outer side piston unit 531 is different from the configuration of the outer side piston unit 31 in the first embodiment. The outer side piston unit 531 is explained in detail below.

The outer side piston unit 531 includes, further on the other side, which is the rod member 21 side, than the compression side valve pressing section 317 in contact with the compression side valve unit 33 and the extension side valve holding section 316 that holds the extension side valve unit 35, a connecting section 531J that makes it possible to divide the outer side piston unit 531.

The connecting section 531J is configured by a male screw and a female screw. The connecting section 531J (a dividing section) makes it possible to divide the outer side piston unit 531 into a first outer side piston unit 531a on one side and a second outer side piston unit 531b on the other side in the axial direction, which is the moving direction of the inner side piston unit 32.

In the piston unit 530 in the fifth embodiment configured as explained above, it is possible to improve assemblability by dividing, with the connecting section 531J, the outer side piston unit 531 into the first outer side piston unit 531a and the second outer side piston unit 531b.

For example, the second outer side piston unit 531b on the other side is fixed to the rod member 21 (see FIG. 1). Thereafter, the inner side piston unit 32, to which the compression side valve unit 33 and the compression side fixing section 34 are attached in advance, is attached to the second outer side piston unit 531b. Finally, the first outer side piston unit 531a, to which the extension side valve unit 35 and the extension side fixing section 36 are attached in advance, is attached to the second outer side piston unit 531b via the connecting section 531J. In this way, in the fifth embodiment, it is possible to complete the piston unit 530 simply by assembling three parts in which a plurality of members are combined and collected.

The connecting section 531J is configured to be connected by a screw structure and can be moved and adjusted in the moving direction of the inner side piston unit 32. Therefore, it is possible to adjust, according to, for example, a tightening amount in the connecting section 531J, a relative positional relation in the axial direction between the inner side piston unit 32 and the outer side piston unit 531. More specifically, in the connecting section 531J, it is possible to adjust both of a relative positional relation of the compression side valve pressing section 317 with the compression side valve unit 33 and a relative positional relation of the extension side valve unit 35 with the extension side valve pressing section 325.

### Sixth Embodiment

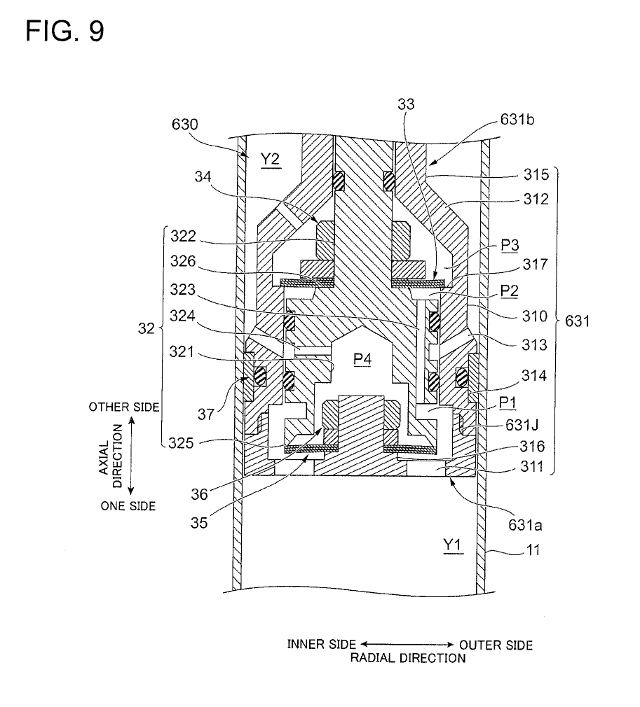

FIG. 9 is a diagram showing a piston unit 630 in a sixth embodiment.

Note that, in the sixth embodiment, components same as the components in the other embodiments are denoted by the same reference numerals and signs and detailed explanation of the components is omitted.

As shown in FIG. 9, in the piston unit 630 in the sixth embodiment, the configuration of an outer side piston unit 631 is different from the configuration of the outer side piston unit 31 in the first embodiment. The outer side piston unit 631 is explained in detail below.

The outer side piston unit 631 includes a second connecting section 631J that makes it possible to divide, in the moving direction of the inner side piston unit 32, the outer side piston unit 631 between the extension side valve holding section 316 and the compression side valve pressing section 317 in the axial direction.

The second connecting section 631J is configured by a male screw and a female screw. The second connecting section 631J divides the outer side piston unit 631 into a first outer side piston unit 631a on one side and a second outer side piston unit 631b on the other side. The second connecting section 631J makes it possible to move and adjust the position of the first outer side piston unit 631a in the axial direction, which is the moving direction of the inner side piston unit 32, with respect to the second outer side piston unit 631b. That is, the second connecting section 631J (an adjusting section or a dividing section) makes it possible to adjust, in the moving direction of the inner side piston unit 32 (the second member), an interval between the extension side valve holding section 316 (a fixing section), which fixes the extension side valve unit 35 (the second valve), and a compression side valve pressing section 317 (a contact section), which is in contact with the compression side valve unit 33 (the first valve).

In the piston unit 630 in the sixth embodiment configured as explained above, it is possible to adjust, according to a tightening amount in the second connecting section 631J, a relative positional relation of the extension side valve unit 35 with the extension side valve pressing section 325. The position adjustment can be performed separately from the adjustment of the relative positional relation between the compression side valve unit 33 and the compression side valve pressing section 317. Therefore, it is possible to perform flexible adjustment for, for example, performing the adjustment of the compression side valve unit 33 and the compression side valve pressing section 317 according to the position adjustment of the inner side piston unit 32 and performing the adjustment of the extension side valve unit 35 and the extension side valve pressing section 325 with the second connecting section 631J.

### Seventh Embodiment

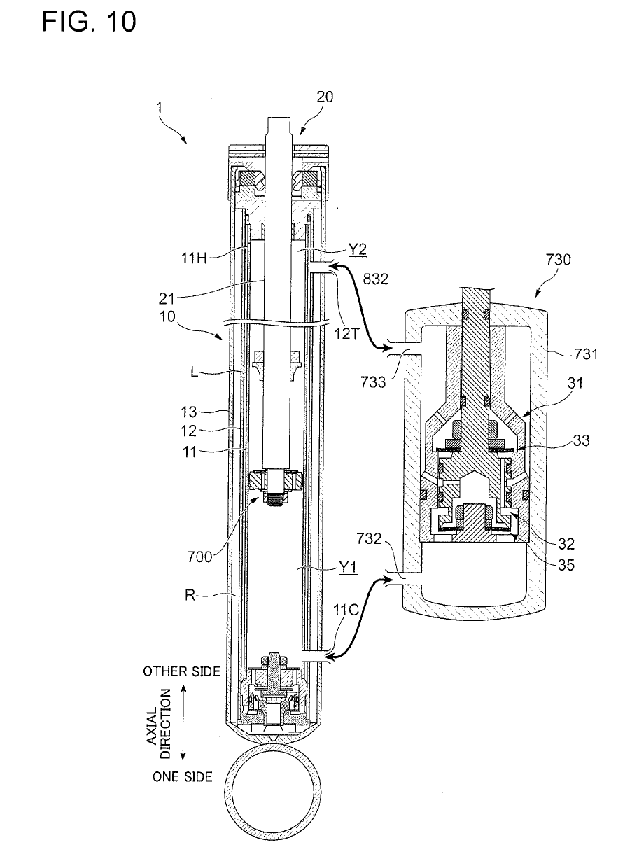

FIG. 10 is a diagram showing the hydraulic-pressure buffering device 1 in a seventh embodiment.

Note that, in the seventh embodiment, components same as the components in the other embodiments are denoted by the same reference numerals and signs and detailed explanation of the components is omitted.

For example, in the example explained in the first embodiment, the mechanism (the piston unit 30) for generating a damping force is provided in the cylinder 11, but such configuration is not limiting and the mechanism for generating a damping force may be disposed separately from the cylinder 11.

In the hydraulic-pressure buffering device 1 in the seventh embodiment, as shown in FIG. 10, in the cylinder 11, a normal piston unit 700 is provided at an end portion on one side of the rod member 21. The hydraulic-pressure buffering device 1 in the seventh embodiment includes a damping-force generating unit 730 on the outside of the cylinder 11. That is, the damping-force generating unit 730 does not move according to amplitude in the axial direction of the rod unit 20.

[Configuration and Functions of the Damping-Force Generating Unit 730]

The damping-force generating unit 730 includes a second cylinder 731 formed in a substantially cylindrical shape and capable of storing the oil. The second cylinder 731 includes a first communication path 732 and a second communication path 733. The second cylinder 731 houses the components of the piston unit 30 in the first embodiment. The outer side piston unit 31 is fixed to the second cylinder 731.

As shown in FIG. 10, the first communication path 732 communicates with a cylinder second opening 11C formed in the cylinder 11 and enabling a flow of the oil to and from the first oil chamber Y1. Meanwhile, the second communication path 733, as shown in FIG. 10, communicates with an outer cylinder body opening 12T formed in the outer cylinder body 12 and enabling a flow of the oil to and from the communication path L. Note that the second communication path 733 may communicate with the second oil chamber Y2.

The hydraulic-pressure buffering device 1 in the seventh embodiment includes, as shown in FIG. 10, the cylinder 11 (the cylinder) that stores the liquid (the oil), the piston unit 700 provided movably in the cylinder axial direction in the cylinder 11, the piston unit 700 partitioning the space in the cylinder 11 into the first oil chamber Y1 (the first liquid chamber) and the second oil chamber Y2 (the second liquid chamber), and the damping-force generating unit 730 (the damping-force generating mechanism).

The damping-force generating unit 730 includes the outer side piston unit 31 (the first member) fixed to the second cylinder 731 (the predetermined member), the inner side piston unit 32 (the second member) provided movably relative to the outer side piston unit 31, a first channel that forms a channel of a flow of the oil from the first oil chamber Y1 to the second oil chamber Y2 caused according to the movement of the piston unit 700, a second channel that forms a channel of a flow of the liquid from the second oil chamber Y2 to the first oil chamber Y1 caused according to the movement of the piston unit 30, the compression side valve unit 33 (the first valve) fixed to the inner side piston unit 32 and brought into contact with the outer side piston unit 31 to control the flow of the oil in the first channel, and the extension side valve unit 35 (the second valve) fixed to the outer side piston unit 31 and brought into contact with the inner side piston unit 32 to control the flow of the oil in the second channel

In the hydraulic-pressure buffering device 1 in the seventh embodiment configured as explained above as well, it is possible to realize, with a simple configuration, changes in damping forces in the damping-force generating unit 730 generated according to movements in both the one direction and the other direction of the piston unit 700.

Note that, for example, in the first embodiment, the outer side piston unit 31 is fixed to the rod unit 20. The inner side piston unit 32 moves relative to the outer side piston unit 31 to thereby perform the change control for the damping forces. However, the change control is not limited to this. That is, the inner side piston unit 32 may be fixed to, for example, the rod unit 20. The outer side piston unit 31 may be moved relative to the inner side piston unit 32 to perform the change control for the damping forces. This is the same in the other embodiments.

The components of the piston units (230, 330, 430, 530, and 630) applied with the second to sixth embodiments may be incorporated in the damping-force generating unit 730 in the hydraulic-pressure buffering device 1 in the seventh embodiment.

Further, in all the embodiments, the hydraulic-pressure buffering device 1 has so-called triple tube structure. However, the hydraulic-pressure buffering device 1 is not limited to this and may have so-called double tube structure. Further, the bottom valve unit 50 is not limited to the structure explained in the embodiments and may have other shapes and configurations as long as the bottom valve unit 50 satisfies functions of a damping mechanism.

### REFERENCE SIGNS LIST

1 Hydraulic-pressure buffering device
10 Cylinder unit
11 Cylinder
20 Rod unit
30 (230, 330, 430, 530, 630) Piston unit
31 Outer side piston unit
32 Inner side piston unit
33 Compression side valve unit
34 Compression side fixing section
35 Extension side valve unit
36 Extension side fixing section
37 Piston ring
730 Damping-force generating unit

1. A pressure buffering device comprising:
a cylinder that stores liquid;
a piston provided movably in a cylinder axial direction in the cylinder, the piston partitioning a space in the cylinder into a first liquid chamber and a second liquid chamber;
a first member fixed to a predetermined member;
a second member provided movably relative to the first member;
a first channel that forms a channel of a flow of the liquid from the first liquid chamber to the second liquid chamber caused according to the movement of the piston;
a second channel that forms a channel of a flow of the liquid from the second liquid chamber to the first liquid chamber caused according to the movement of the piston;
a first valve fixed to the second member and brought into contact with the first member to control the flow of the liquid in the first channel; and
a second valve fixed to the first member and brought into contact with the second member to control the flow of the liquid in the second channel.

2. The pressure buffering device according to claim 1,
wherein the pressure buffering device comprises, separately from the first channel and the second channel, a bypass path that forms a channel of the liquid between the first liquid chamber and the second liquid chamber while narrowing the flow of the liquid.

3. The pressure buffering device according to claim 1,
wherein the first member is formed in a hollow shape and includes a first through-hole into which the liquid flows when the liquid flows from the first liquid chamber to the second liquid chamber and a second through-hole into which the liquid flows when the liquid flows from the second liquid chamber to the first liquid chamber, and
wherein the second member is provided on an inner side of the first member and includes an inner side channel that enables a flow of the liquid between the first through-hole and the second through-hole.

4. The pressure buffering device according to claim 1,
wherein the first member includes a dividing section dividable in a moving direction of the second member.

5. The pressure buffering device according to claim 1,
wherein the first member includes an adjusting section capable of adjusting, in a moving direction of the second member, an interval between a fixing section that fixes the second valve and a contact section in contact with the first valve.

6. A damping-force generating mechanism comprising:
a first member fixed to a predetermined member;
a second member provided movably relative to the first member;
a first channel that forms a channel of a flow of liquid from a first liquid chamber to a second liquid chamber caused according to movement of a piston that partitions a space in a cylinder, which stores the liquid, into the first liquid chamber and the second liquid chamber;
a second channel that forms a channel of a flow of the liquid from the second liquid chamber to the first liquid chamber caused according to the movement of the piston;
a first valve fixed to the second member and brought into contact with the first member to control the flow of the liquid in the first channel; and
a second valve fixed to the first member and brought into contact with the second member to control the flow of the liquid in the second channel.
